(19) United States
(12) Patent Application Publication
(10) Pub. No.: US 2026/0321985 A1
(43) Pub. Date: Oct. 15, 2026

(54) LEAKY-WAVE ANTENNA AND COMMUNICATION DEVICE

(71) Applicant: HUAWEI TECHNOLOGIES CO., LTD., Shenzhen (CN)

(72) Inventors: Xin Feng, Chengdu (CN); Bang Wei, Beijing (CN); Zheng Li, Beijing (CN); Zhenyu Qiao, Beijing (CN)

(73) Assignee: HUAWEI TECHNOLOGIES CO., LTD., Shenzhen (CN)

(21) Appl. No.: 19/691,400

(22) Filed: May 28, 2026

Related U.S. Application Data
(63) Continuation of application No. PCT/CN2024/113956, filed on Aug. 22, 2024.

(30) Foreign Application Priority Data
Nov. 29, 2023 (CN) 202311628332.X

(51) Int. Cl. H01Q 13/20

(52) U.S. Cl. CPC H01Q 13/20

(57) ABSTRACT

Embodiments of this application provide a leaky-wave antenna and a communication device, to improve communication performance of the leaky-wave antenna. According to the leaky-wave antenna provided in this application, a waveguide structure includes a plurality of transmission channels, a plurality of slots are provided in an array at a grounding layer, and slots of each row correspond to one transmission channel. There are a plurality of radiators, and each radiator corresponds to one slot. There are a plurality of variable impedance devices, each variable impedance device corresponds to one slot and is located on a side that is of the slot and that faces the transmission channel, one end of each variable impedance device is grounded, and the other end of each variable impedance device is connected to one bias line.

### CROSS-REFERENCE TO RELATED APPLICATIONS

This application is a continuation of International Application No. PCT/CN 2024/113956, filed on Aug. 22, 2024, which claims priority to Chinese Patent Application No. 202311628332.X, filed on Nov. 29, 2023. The disclosures of the aforementioned applications are hereby incorporated by reference in their entireties.

### TECHNICAL FIELD

Embodiments of this application relate to the field of communication technologies, and specifically, to a leaky-wave antenna and a communication device.

### BACKGROUND

A leaky-wave antenna includes waveguides, radiators, and PIN diodes. There are a plurality of waveguides, there is one transmission channel for each waveguide, transmission channels are disposed in parallel at intervals, and a plurality of slots are provided, on each transmission channel, at intervals along a signal transmission direction. In other words, the slots are provided in an array. There are a plurality of radiators, the plurality of radiators are disposed in an array, and each radiator corresponds to one slot. One PIN diode is disposed between each slot and a transmission channel, PIN diodes are disposed in an array, one end of each PIN diode is grounded, PIN diodes that correspond to each transmission channel are located in a same row, and the other ends of PIN diodes in a same column are connected through a same bias line. During operation, a signal on a transmission channel is coupled to corresponding radiators through slots, so that the radiators transmit the signal outwards. A status of the PIN diodes in the same column may be controlled via the bias line, so that the signal may be controlled to pass through the corresponding slots. However, the other ends of the PIN diodes in the same column are connected through the same bias line, and a beam formed by each waveguide is identical. Consequently, communication performance of the leaky-wave antenna is poor.

### SUMMARY

Embodiments of this application provide a leaky-wave antenna and a communication device, to improve communication performance of the leaky-wave antenna.

To achieve the foregoing objective, the following technical solutions are used in embodiments of this application.

On one hand, an embodiment of this application provides a leaky-wave antenna, including a waveguide structure, a grounding layer, radiators, and variable impedance devices. The waveguide structure includes a plurality of transmission channels, and the transmission channels are disposed in parallel at intervals. A plurality of slots are provided in an array at the grounding layer, and slots of each row correspond to one transmission channel. There are a plurality of radiators, and each radiator corresponds to one slot and is located on a side that is of the slot and that is away from the transmission channel. There are a plurality of variable impedance devices, each variable impedance device corresponds to one slot and is located on a side that is of the slot and that faces the transmission channel, one end of each variable impedance device is grounded, and the other end of each variable impedance device is connected to one bias line.

According to the leaky-wave antenna provided in this application, the waveguide structure includes a plurality of transmission channels, the transmission channels are disposed in parallel at intervals, a plurality of slots are provided in an array at the grounding layer, and slots of each row correspond to one transmission channel. There are a plurality of radiators, and each radiator corresponds to one slot and is located on a side that is of the slot and that is away from the transmission channel. There are a plurality of variable impedance devices, each variable impedance device corresponds to one slot and is located on a side that is of the slot and that faces the transmission channel, one end of each variable impedance device is grounded, and the other end of each variable impedance device is connected to one bias line. A variable impedance device connected to a bias line may be controlled via the bias line, to control a radiator corresponding to the variable impedance device to transmit a signal outwards. Each variable impedance device is connected to one bias line, so that each radiator can be separately controlled, and a beam formed in each transmission channel can be separately controlled, thereby improving communication performance of the leaky-wave antenna.

In some embodiments, the leaky-wave antenna further includes a first conductive layer, where the first conductive layer and the grounding layer are disposed in parallel at intervals, and the first conductive layer is located on a side that is of the grounding layer and that faces the transmission channels. The first conductive layer includes a plurality of pads and bias lines, each pad is grounded, and one end of each variable impedance device is connected to one pad.

Based on the foregoing arrangement, one end of the variable impedance device is grounded via the pad, and the other end of the variable impedance device is connected to one bias line, so that each bias line can be used to control each variable impedance device to be turned off or turned on, and whether a corresponding radiator transmits a signal outwards is separately controlled.

In some embodiments, a first conductive structure is disposed between each pad and the grounding layer, and the pad is connected to the grounding layer via the first conductive structure.

Based on the foregoing arrangement, because the grounding layer and the pad at the first conductive layer both need to be grounded, after the first conductive structure connects the pad to the grounding layer, the grounding layer and the pad can be both grounded by grounding only the pad or the grounding layer, thereby reducing a quantity of ground lines of the leaky-wave antenna, and reducing difficulty in manufacturing ground lines of the leaky-wave antenna.

In some embodiments, the leaky-wave antenna further includes a second conductive layer, where the second conductive layer and the grounding layer are disposed in parallel at intervals, and the second conductive layer is located on a side that is of the grounding layer and that is away from the first conductive layer. The second conductive layer includes a plurality of first conducting lines disposed at intervals, and each first conducting line is connected to one bias line.

Based on the foregoing arrangement, each bias line is connected to a corresponding first conducting line, and energizing the first conducting line is equivalent to energizing the bias line connected to the first conducting line, so that the bias line supplies a voltage to the variable impedance device. In addition, because the second conductive layer is located on the side that is of the grounding layer and that is away from the first conductive layer, that is, the first conducting line and the bias line are disposed at different layers, a layout of the first conducting line is flexible, so that an interconnection between adjacent first conducting lines can be avoided, and an interconnection between adjacent bias lines can also be avoided.

In some embodiments, a second conductive structure is disposed between each first conducting line and the corresponding bias line, and the first conducting line is connected to the corresponding bias line via the second conductive structure.

Based on the foregoing arrangement, because the first conducting line and the bias line are disposed at different layers, one end of the second conductive structure is connected to the first conducting line, and the other end of the second conductive structure is connected to the corresponding bias line, thereby implementing a connection between the first conducting line and the corresponding bias line.

In some embodiments, a first clearance hole is provided at the grounding layer, and the second conductive structure passes through the first clearance hole.

Based on the foregoing arrangement, because the grounding layer needs to be grounded, the second conductive structure passes through the first clearance hole, so that insulation between the second conductive structure and the grounding layer is implemented, thereby avoiding a failure of the corresponding bias line caused by an electric leakage between the second conductive structure and the grounding layer.

In some embodiments, the leaky-wave antenna further includes a third conductive layer, where the third conductive layer and the grounding layer are disposed in parallel at intervals, and the third conductive layer is located between the second conductive layer and the grounding layer. The third conductive layer includes a plurality of second conducting lines disposed at intervals, where each second conducting line is connected to one bias line, several bias lines are connected to the second conducting lines, and remaining bias lines are connected to the first conducting lines.

Based on the foregoing arrangement, one bias line is connected to a corresponding second conducting line. In this case, energizing the second conducting line is equivalent to energizing the bias line connected to the second conducting line, so that the bias line supplies a voltage to the variable impedance device. In addition, because the third conductive layer is located between the second conductive layer and the grounding layer, that is, the second conducting line and the bias line are disposed at different layers, a layout of the second conducting line is flexible, so that an interconnection between adjacent second conducting lines can be avoided, and an interconnection between adjacent corresponding bias lines can also be avoided. In addition, because several bias lines are connected to the second conducting lines, remaining bias lines are connected to the first conducting lines, and the third conductive layer and the second conductive layer are different layers, compared with an embodiment in which the leaky-wave antenna includes only the second conductive layer, the third conductive layer may be connected to another bias line, thereby increasing a quantity of radiators that may be disposed for the leaky-wave antenna, and facilitating expansion of the leaky-wave antenna along a row direction or a column direction.

In some embodiments, a third conductive structure is disposed between each second conducting line and the corresponding bias line, and the second conducting line is connected to the corresponding bias line via the third conductive structure.

Based on the foregoing arrangement, because the second conducting line and the bias line are disposed at different layers, one end of the third conductive structure is connected to the second conducting line, and the other end of the third conductive structure is connected to the corresponding bias line, thereby implementing a connection between the second conducting line and the corresponding bias line.

In some embodiments, a second clearance hole is provided at the grounding layer, and the third conductive structure passes through the second clearance hole.

Based on the foregoing arrangement, because the grounding layer needs to be grounded, the third conductive structure passes through the second clearance hole, so that insulation between the third conductive structure and the grounding layer is implemented, thereby avoiding a failure of the corresponding bias line caused by an electric leakage between the third conductive structure and the grounding layer.

In some embodiments, the leaky-wave antenna further includes a plurality of pins, each pin is connected to one bias line, and a center line of the pin is perpendicular to the grounding layer.

Based on the foregoing arrangement, each bias line is connected to a corresponding pin. In this case, energizing the pin is equivalent to energizing the bias line connected to the pin, so that the bias line supplies a voltage to the variable impedance device. In addition, because the center line of the pin is perpendicular to the grounding layer, the bias line is not led out along a row direction or a column direction, and a size of the leaky-wave antenna in the row direction or the column direction can be reduced, so that a quantity of radiators is increased for the leaky-wave antenna in the row direction or the column direction.

In some embodiments, the leaky-wave antenna further includes a first dielectric layer, a second dielectric layer, and a plurality of through-holes disposed in an array. The first dielectric layer is disposed, in a stacked manner, between the grounding layer and the variable impedance device. The second dielectric layer is disposed, in a stacked manner, between the grounding layer and the radiator. Each through-hole runs through the first dielectric layer and the second dielectric layer, and each pin is arranged through one through-hole. A conductive side wall is disposed at a through-hole wall of the through-hole, and the conductive side wall is connected to a corresponding bias line.

Based on the foregoing arrangement, each pin is inserted into a corresponding through-hole, and is connected to the corresponding bias line through the conductive side wall of the through-hole.

In some embodiments, a projection that is of one row of pins corresponding to one row of slots and that is on the waveguide structure is located between adjacent transmission channels.

Based on the foregoing arrangement, the pin is located between adjacent transmission channels, so that the pin can be prevented from affecting transmission of an electromagnetic wave on the transmission channel.

In some embodiments, the leaky-wave antenna further includes a power splitter, where the power splitter includes an input end and a plurality of output ends, each output end is connected to the input end, and each output end is configured to send a signal to one transmission channel.

Based on the foregoing arrangement, all the output ends may output electromagnetic waves with a same amplitude and a same phase, so that electromagnetic waves transmitted in all transmission channels have a same amplitude and a same phase.

In some embodiments, there are two power splitters, one power splitter is disposed at one end of the transmission channel, and the other power splitter is disposed at the other end of the transmission channel.

Based on the foregoing arrangement, the power splitter at one end of the transmission channel is configured to input an electromagnetic wave into the transmission channel, and the power splitter at the other end of the transmission channel is configured to integrate electromagnetic waves transmitted from the transmission channel and release the electromagnetic waves into air.

In some embodiments, the waveguide structure includes a bottom plate and a plurality of pillars disposed on the bottom plate, the plurality of pillars are disposed in an array, and the transmission channel is formed between two adjacent rows of pillars.

Based on the foregoing arrangement, two adjacent rows of pillars forming the transmission channel can prevent an electromagnetic wave on the transmission channel from being propagated to another transmission channel, prevent mutual interference between electromagnetic waves in adjacent transmission channels, and reduce a loss generated when the electromagnetic waves are transmitted on the transmission channels.

In some embodiments, the waveguide structure further includes a plurality of first ridge structures, and the plurality of first ridge structures are located on the transmission channels and extend along a signal transmission direction.

Based on the foregoing arrangement, the first ridge structure is disposed on the transmission channel, which is equivalent to moving a ground plane into the transmission channel, limiting an electric field on the transmission channel, increasing capacitance of the transmission channel, and reducing a cut-off frequency of the waveguide structure, thereby reducing a frequency of an electromagnetic wave transmitted on the transmission channel, to enable the electromagnetic wave to become a slow wave.

On the other hand, an embodiment of this application further provides a communication device. The communication device includes a radio frequency unit and the foregoing leaky-wave antenna, and the radio frequency unit is configured to send a radio frequency signal to the leaky-wave antenna.

It may be understood that, for beneficial effects that can be achieved by the communication device provided in the foregoing embodiment of this application, refer to the beneficial effects of the leaky-wave antenna in the foregoing descriptions. Details are not described herein.

### BRIEF DESCRIPTION OF DRAWINGS

To describe the technical solutions of this application more clearly, the following briefly describes the accompanying drawings for describing some embodiments of this application. It is clear that the accompanying drawings in the following descriptions are merely accompanying drawings in some embodiments of this application. A person of ordinary skill in the art may further derive another drawing from these accompanying drawings. In addition, the accompanying drawings in the following descriptions may be considered as diagrams, and are not intended to limit an actual size of a product, an actual procedure of a method, an actual time sequence of a signal, and the like in embodiments of this application.

FIG. 1 is a diagram of a connection in a communication device according to an embodiment of this application;

FIG. 2 is an isometric diagram of a leaky-wave antenna according to an embodiment of this application;

FIG. 3 is a diagram of a structure of a waveguide structure according to an embodiment of this application;

FIG. 4 is a cross-sectional diagram of a waveguide structure according to an embodiment of this application;

FIG. 5 is a diagram of a structure of a waveguide structure according to an embodiment of this application;

FIG. 6 is a diagram 1 of a structure of a leaky-wave antenna according to an embodiment of this application;

FIG. 7 is a diagram 2 of a structure of a leaky-wave antenna according to an embodiment of this application;

FIG. 8 is a diagram 3 of a structure of a leaky-wave antenna according to an embodiment of this application;

FIG. 9 is a curve diagram of an amplitude of an electromagnetic wave radiated by a corresponding radiator at different frequencies of the electromagnetic wave when a PIN diode is turned off and an amplitude of an electromagnetic wave radiated by the corresponding radiator at different frequencies of the electromagnetic wave when the PIN diode is turned on according to an embodiment of this application;

FIG. 10 is diagrams of solutions for controlling radiators disposed in an array according to an embodiment of this application;

FIG. 11 is diagrams of formed beams corresponding to the solutions in FIG. 10 according to an embodiment of this application;

FIG. 12 is a diagram of a structure of a second conductive layer according to an embodiment of this application;

FIG. 13 is a diagram of a connection between first conducting lines and radiators according to an embodiment of this application;

FIG. 14 is a diagram 4 of a structure of a leaky-wave antenna according to an embodiment of this application;

FIG. 15 is a diagram 5 of a structure of a leaky-wave antenna according to an embodiment of this application;

FIG. 16 is a diagram of a structure of a third conductive layer according to an embodiment of this application;

FIG. 17 is a diagram 6 of a structure of a leaky-wave antenna according to an embodiment of this application;

FIG. 18 is a diagram 7 of a structure of a leaky-wave antenna according to an embodiment of this application;

FIG. 19 is a diagram of a position relationship between radiators and pins according to an embodiment of this application;

FIG. 20 is a diagram of a position relationship between pins and a transmission channel according to an embodiment of this application;

FIG. 21 is a diagram of a structure of a power splitter according to an embodiment of this application;

FIG. 22 is a curve diagram of phases of electromagnetic waves output by output ends of a power splitter at different frequencies of the electromagnetic waves according to an embodiment of this application; and

FIG. 23 is a curve diagram of reflection coefficients of electromagnetic waves output by output ends of a power splitter at different frequencies of the electromagnetic waves according to an embodiment of this application.

Reference numerals: 1. Communication device; 2. Building baseband unit; 3. Radio frequency unit; 4. Leaky-wave antenna; 5. Waveguide structure; 6. Grounding layer; 7. Radiator; 8. Bottom plate; 9. Pillar; 10. Transmission channel; 11. First ridge structure; 12. Slot; 13. First radiator; 14. Second radiator; 15. Variable impedance device; 16. Bias line; 17. PIN diode; 18. First dielectric layer; 19. Second dielectric layer; 20. First prepreg; 21. First conductive layer; 22. Pad; 23. First conductive structure; 24. Second conductive layer; 25. First conducting line; 26. Second conductive structure; 27. Third dielectric layer; 28. Second prepreg; 29. First clearance hole; 30. Third conductive layer; 31. Second conducting line; 32. Third conductive structure; 33. Second clearance hole; 34. Pin; 35. Through-hole; 36. Conductive side wall; 37. Waveguide sub-structure; 38. First pillar; 39. Second pillar; 40. Third clearance hole; 41. Power splitter; 42. Input end; 43. Output end; 44. Input channel; 45. Second ridge structure.

### DESCRIPTION OF EMBODIMENTS

To make the objectives, technical solutions, and advantages of embodiments of this application clearer, the following clearly and completely describes the technical solutions in embodiments of this application with reference to the accompanying drawings in embodiments of this application. It is clear that the described embodiments are some rather than all of embodiments of this application. All other embodiments obtained by a person of ordinary skill in the art based on embodiments of this application without creative efforts shall fall within the protection scope of this application.

The terms “first” and “second” mentioned below are merely intended for description, and shall not be understood as an indication or implication of relative importance or implicit indication of a quantity of indicated technical features. Therefore, a feature limited by “first”, “second”, or the like may explicitly or implicitly include one or more such features.

In addition, in embodiments of this application, orientation terms such as “on”, “below”, “left”, “right”, “horizontal”, and “vertical” are defined relative to placement orientations of components shown in the accompanying drawings. It should be understood that these directional terms are relative concepts that are used for relative descriptions and clarification, and may vary with a change in the placement orientations of the components in the accompanying drawings.

In embodiments of this application, unless otherwise clearly specified and limited, a term “connection” should be understood in a broad sense. For example, the “connection” may be a fixed connection, a detachable connection, or an integral connection, may be a direct connection, or may be an indirect connection through an intermediate medium.

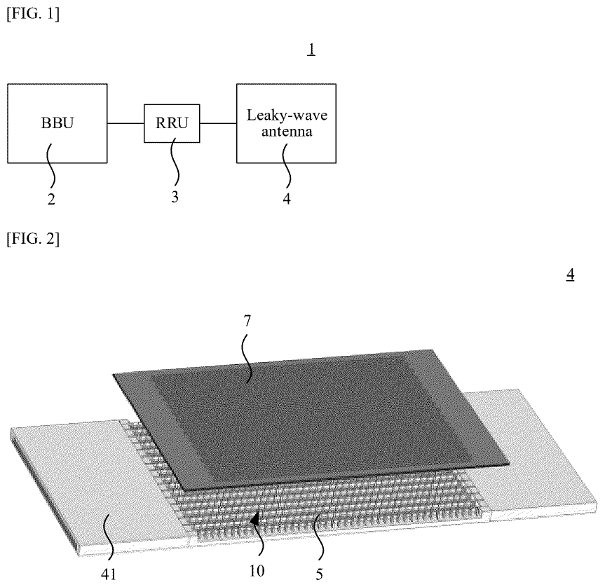

Refer to FIG. 1. An embodiment of this application provides a communication device 1. The communication device 1 may include a communication base station, an electronic device, and the like. In an implementation in which the communication device 1 includes the communication base station, the communication device 1 may include a BBU (Building Baseband Unit, building baseband unit 2), an RRU (Radio Remote Unit, radio remote unit (referred to as a radio frequency unit 3 in this embodiment of this application)), and a leaky-wave antenna 4. One end of the radio frequency unit 3 is connected to the building baseband unit 2, and the other end of the radio frequency unit 3 is connected to the leaky-wave antenna 4. The building baseband unit 2 is configured to complete channel encoding and decoding, modulation and demodulation of a baseband signal, and protocol processing, including generating a control instruction and generating a radio frequency signal. The leaky-wave antenna 4 is configured to send and receive a radio frequency signal. The radio frequency unit 3 is configured to send a control instruction and a radio frequency signal to the leaky-wave antenna 4, and is also configured to transmit the radio frequency signal received by the leaky-wave antenna 4 to the building baseband unit 2. The leaky-wave antenna 4 in this embodiment of this application should be understood as being used in cooperation with the radio frequency unit 3. The leaky-wave antenna 4 transmits, in a form of a wireless signal, the radio frequency signal sent by the radio frequency unit 3 to the air. The leaky-wave antenna 4 may include a remote electrical tilting antenna, a mechanical antenna, and the like.

It may be understood that, in this embodiment of this application, information exchange (including exchange of an antenna control instruction, a transmission operation result, and the like) between the radio frequency unit 3 and the leaky-wave antenna 4 is performed via a radio frequency coaxial cable. In an implementation in which the communication device 1 includes the electronic device, the electronic device may include a housing, a radio frequency unit 3, and a leaky-wave antenna 4. Both the leaky-wave antenna 4 and the radio frequency unit 3 are disposed inside the housing. The electronic device may further include a controller. The controller is also disposed inside the housing, and the controller is electrically connected to the leaky-wave antenna 4 and the radio frequency unit 3.

In the foregoing implementation, the electronic device may include a wireless router, a mobile phone, or the like. In an implementation in which the electronic device includes the wireless router, the leaky-wave antenna 4 may include a Wi-Fi (Wireless Fidelity, wireless fidelity) antenna. In an implementation in which the electronic device includes the mobile phone, the leaky-wave antenna 4 may include a main antenna or a diversity antenna, or include both a main antenna and a diversity antenna. The main antenna is responsible for sending and receiving a signal, and the diversity antenna is only responsible for receiving a signal, but not responsible for sending a signal. In an implementation in which the leaky-wave antenna 4 includes both the main antenna and the diversity antenna, a signal received by the main antenna and a signal received by the diversity antenna may be combined, to improve a receiving effect of the leaky-wave antenna 4.

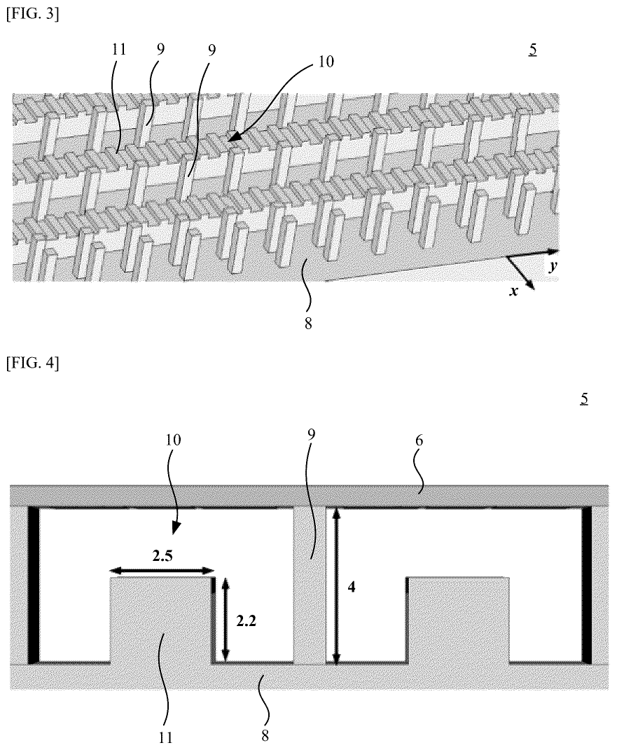

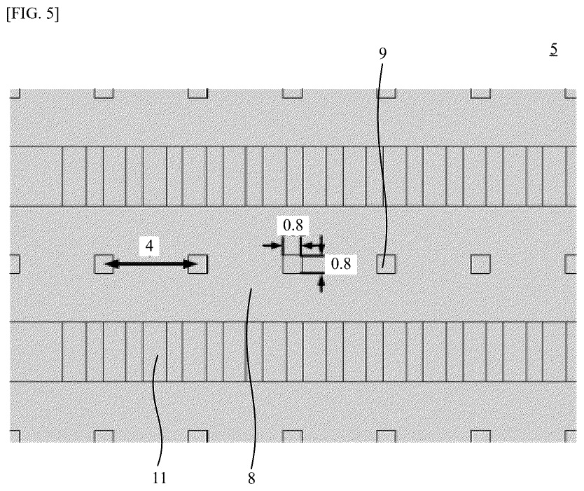

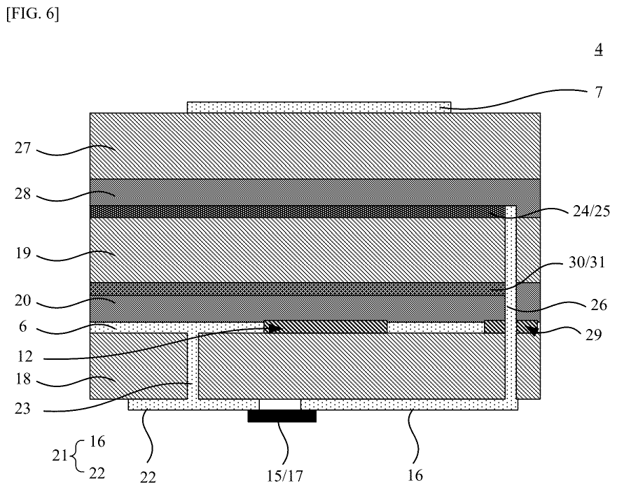

Refer to FIG. 2. The leaky-wave antenna 4 provided in this embodiment of this application may include a waveguide structure 5, a grounding layer 6 (as shown in FIG. 6), and radiators 7. The waveguide structure 5 may include a groove gap waveguide, a ridge gap waveguide, and the like. In this embodiment of this application, the waveguide structure 5 is configured to: receive a radio frequency signal (that is, the waveguide structure 5 is configured to receive an electromagnetic wave), and couple the signal to the radiator 7, so that the radiator 7 transmits the signal outwards. Refer to FIG. 3. The waveguide structure 5 may include a bottom plate 8 and a plurality of pillars 9 disposed on the bottom plate 8. The plurality of pillars 9 are disposed in an array, and a transmission channel 10 is formed between two adjacent rows of pillars 9 (in FIG. 3, an x direction is a column direction of the pillars, and a y direction is a row direction of the pillars). In this case, the waveguide structure 5 may include a plurality of transmission channels 10, the transmission channels 10 are disposed in parallel at intervals, and an extension direction of the transmission channel 10 is parallel to the row direction of the array of the pillars 9. A signal received by the waveguide structure 5 is transmitted in each transmission channel 10 along the extension direction of the transmission channel 10, and a main propagation mode of electromagnetic waves on the transmission channels 10 is a TE10 mode (where a TE mode is a transverse electric mode, that is, a transverse electric mode). Both the bottom plate 8 and the pillars 9 may be made of metal materials. Based on the foregoing arrangement, the two adjacent rows of pillars 9 forming the transmission channel 10 can prevent an electromagnetic wave on the transmission channel 10 from being propagated to another transmission channel 10, prevent mutual interference between electromagnetic waves in adjacent transmission channels 10, and reduce a loss generated when the electromagnetic waves are transmitted on the transmission channels 10. Refer to FIG. 4. For example, a center line of a pillar 9 may be perpendicular to a bottom plate 8, and a height (a length along a direction parallel to the center line) of the pillar 9 may be 2 mm to 6 mm (for example, 2 mm, 4 mm, or 6 mm). Refer to FIG. 5. A projection of the pillar 9 on the bottom plate 8 may be of a regular shape like a circle or a rectangle. Certainly, the projection may alternatively be of another irregular shape. In an implementation in which the projection is the rectangle, an edge length of the rectangle may be 0.6 mm to 1 mm. For example, the rectangle may be a 0.8 mm*0.8 mm square. In the row direction, a spacing between center lines of two adjacent pillars 9 may be 2 mm to 6 mm (for example, 2 mm, 4 mm, or 6 mm); and in the column direction, a spacing between two adjacent pillars 9 may be 6.8 mm to 8 mm (for example, 6.8 mm, 7.4 mm, or 8 mm).

It may be understood that signals transmitted in the transmission channels 10 may be intra-frequency signals, or may be inter-frequency signals. This is not limited in embodiments of this application.

Still refer to FIG. 3. In the foregoing embodiment, the waveguide structure 5 may further include a plurality of first ridge structures 11, the plurality of first ridge structures 11 are located on the transmission channels 10, one first ridge structure 11 is disposed in each transmission channel 10, and the first ridge structure 11 extends along a signal transmission direction. The first ridge structures 11 are disposed on the bottom plate 8. Refer to FIG. 4. A side that is of the first ridge structure 11 and that is away from the bottom plate 8 is closer to the bottom plate 8 than an end that is of the pillar 9 and that is away from the bottom plate 8. In other words, a height of the first ridge structure 11 is less than the height of the pillar 9. Based on the foregoing arrangement, the first ridge structure 11 is disposed on the transmission channel 10, which is equivalent to moving a ground plane into the transmission channel 10, limiting an electric field on the transmission channel 10, increasing capacitance of the transmission channel 10, and reducing a cut-off frequency of the waveguide structure 5. It can be understood that when a signal frequency is higher than the cut-off frequency, a signal can pass through; or when a signal frequency is lower than the cut-off frequency, signal output is greatly attenuated. Therefore, after the cut-off frequency of the waveguide structure 5 is reduced via the first ridge structure 11, a frequency of the electromagnetic wave transmitted on the transmission channel 10 can be reduced, to enable the electromagnetic wave to become a slow wave. Still refer to FIG. 4. For example, a length of the first ridge structure 11 in a row direction may be approximately equal to a length of the transmission channel 10; a width of the first ridge structure 11 in a column direction may be 2.3 mm to 2.7 mm (for example, 2.3 mm, 2.5 mm, or 2.7 mm), where in the column direction, the first ridge structure 11 may be located at a center position of two adjacent pillars 9. A height of the first ridge structure 11 (a length of a surface that is of the first ridge structure 11, that is perpendicular to the bottom plate 8, and that is connected to the first ridge structure 11) may be 2 mm to 2.4 mm (for example, 2 mm, 2.2 mm, or 2.4 mm). In some embodiments, the height of the first ridge structure 11 may periodically change along the row direction. In other words, the first ridge structure 11 includes a plurality of protrusions and a plurality of recesses that alternate with each other in sequence along the row direction.

Still refer to FIG. 4 and FIG. 6. In embodiments of this application, the grounding layer 6 covers the waveguide structure 5, the grounding layer 6 and the bottom plate 8 are disposed in parallel at intervals, the pillars 9 are located between the bottom plate 8 and the grounding layer 6, the grounding layer 6 can seal the transmission channels 10, and the radiators 7 are disposed on a side that is of the grounding layer 6 and that is away from the transmission channels 10 (as shown in FIG. 2). A plurality of slots 12 are provided, in an array, at the grounding layer 6. Slots 12 of each row correspond to one transmission channel 10. The radiator 7 is located on a side that is of the slot 12 and that is away from the transmission channel 10. Each radiator 7 is corresponding to one slot 12. A signal on the transmission channel 10 may be coupled to a corresponding radiator 7 through a slot 12, so that the radiator 7 transmits the signal outwards.

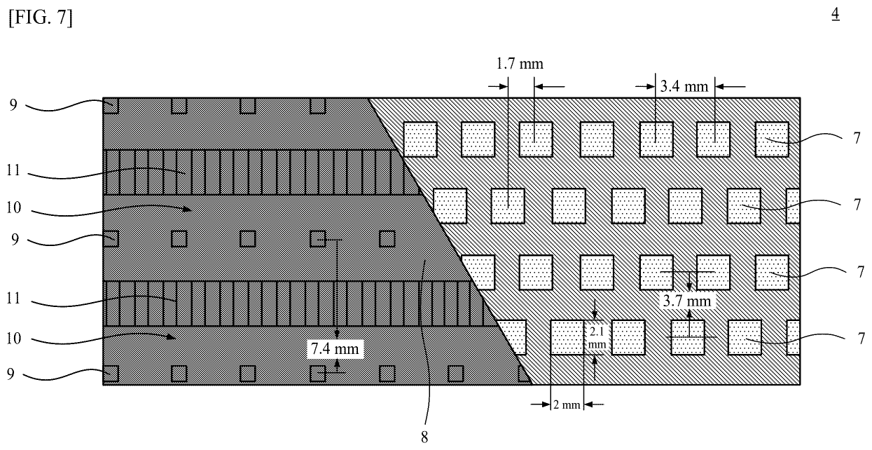

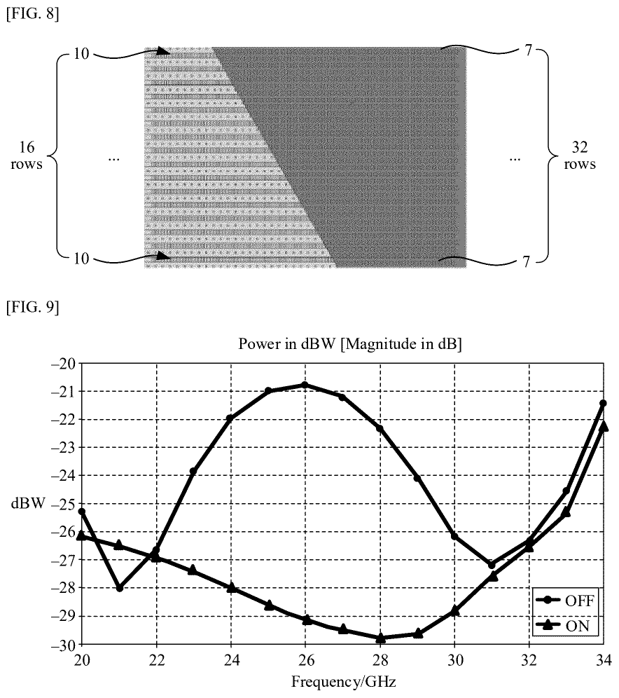

Refer to FIG. 7. In some embodiments, two rows of slots 12 are provided in correspondence with each transmission channel 10 (as shown in FIG. 6). In other words, two rows of radiators 7 are disposed in correspondence with each transmission channel 10. Refer to FIG. 8. For example, the waveguide structure 5 includes 16 rows of transmission channels 10, and the leaky-wave antenna 4 includes 32 rows of radiators 7. Still refer to FIG. 7. In the foregoing embodiment in which the spacing between the two adjacent pillars 9 is 7.4 mm, a spacing between geometrical centers of two adjacent rows of radiators 7 may be 3.7 mm. Two rows of radiators 7 that are disposed in correspondence with a same transmission channel 10 include a plurality of first radiators 13 in a 1st row of radiators 7 and a plurality of second radiators 14 in a 2nd row of radiators 7, and a first straight line along a column direction of the first radiator 13 is in the middle of two second straight lines along a column direction of two adjacent second radiators 14. For example, a spacing between geometrical centers of two adjacent first radiators 13 is 3.4 mm in a row direction, and a spacing between a geometrical center of a first radiator 13 and a geometrical center of a second radiator 14 adjacent to the first radiator 13 is 1.7 mm in the row direction. In the foregoing embodiment, a length of a projection of the radiator 7 in a direction perpendicular to an array is 2 mm in the row direction, and a length of the projection is 2.1 mm in the column direction.

Still refer to FIG. 6. In the foregoing embodiment, the leaky-wave antenna 4 may further include variable impedance devices 15. There may be a plurality of variable impedance devices 15. Each variable impedance device 15 corresponds to one slot 12, and is located on a side that is of the slot 12 and that faces the transmission channel 10 (as shown in FIG. 3). One end of each variable impedance device 15 is grounded, and the other end of each variable impedance device 15 is connected to one bias line 16. For example, the variable impedance device 15 may include a PIN diode 17, where one end of the PIN diode 17 is grounded, the other end of the PIN diode 17 is connected to one bias line 16, and the bias line 16 is configured to supply a voltage to the PIN diode 17, to change a switch status of the PIN diode 17. With reference to FIG. 6 and FIG. 9, FIG. 9 shows an amplitude of an electromagnetic wave radiated by a corresponding radiator 7 at different frequencies of the electromagnetic wave when a PIN diode 17 is turned off and an amplitude of an electromagnetic wave radiated by the corresponding radiator 7 at different frequencies of the electromagnetic wave when the PIN diode 17 is turned on. It can be learned that for a range of a frequency of the electromagnetic wave from 24 GHz to 28 GHz, there is a great difference between an amplitude of the electromagnetic wave radiated by the corresponding radiator 7 when the PIN diode 17 is turned off and an amplitude of the electromagnetic wave radiated by the corresponding radiator 7 when the PIN diode 17 is turned on, which indicates that whether the radiator 7 radiates an electromagnetic wave may be controlled by turning off or turning on the corresponding PIN diode 17 via a bias line 16. In other words, for the range of the frequencies of the electromagnetic wave from 24 GHz to 28 GHz, when the PIN diode 17 is in an off state, a part of an electromagnetic wave on the transmission channel 10 can pass through the PIN diode 17 and be coupled to the corresponding radiator 7 through a slot 12, so that the radiator 7 transmits a signal outwards. When the PIN diode 17 is in an on state, an electromagnetic wave on the transmission channel 10 does not pass through the PIN diode 17, and continues to be transmitted along the transmission channel 10.

Still refer to FIG. 6. In some embodiments, the leaky-wave antenna 4 may include a first dielectric layer 18 and a second dielectric layer 19. The first dielectric layer 18 is disposed, in a stacked manner, between the grounding layer 6 and the variable impedance devices 15, and the second dielectric layer 19 is disposed, in a stacked manner, between the grounding layer 6 and the radiators 7. The radiators 7, the grounding layer 6, and the variable impedance devices 15 may be connected together via the first dielectric layer 18 and the second dielectric layer 19, to facilitate assembly of the leaky-wave antenna 4. For example, the first dielectric layer 18 and the second dielectric layer 19 may be bonded together via a first prepreg 20, where all of the first dielectric layer 18, the second dielectric layer 19, and the first prepreg 20 may be made of insulating materials. For example, a thickness of the first dielectric layer 18 is 0.508 mm, a thickness of the second dielectric layer 19 is 0.101 mm, and a thickness of the first prepreg 20 is 0.2 mm. The grounding layer 6 is located between the first dielectric layer 18 and the first prepreg 20, and the first dielectric layer 18 covers a side that is of a waveguide structure 5 and that is away from the bottom plate 8.

In the leaky-wave antenna 4 provided in this application, the waveguide structure 5 includes a plurality of transmission channels 10, the transmission channels 10 are disposed in parallel at intervals, a plurality of slots 12 are provided in an array at the grounding layer 6, slots 12 of each row correspond to one transmission channel 10, there are a plurality of radiators 7, and each radiator 7 corresponds to one slot 12, and is located on a side that is of the slot 12 and that is away from the transmission channel 10. There are a plurality of variable impedance devices 15. Each variable impedance device 15 corresponds to one slot 12, and is located on a side that is of the slot 12 and that faces the transmission channel 10. One end of each variable impedance device 15 is grounded, and the other end of each variable impedance device 15 is connected to one bias line 16. A variable impedance device 15 connected to a bias line 16 may be controlled via the bias line 16, to control a radiator 7 corresponding to the variable impedance device 15 to transmit a signal outwards. Each variable impedance device 15 is connected to one bias line 16, so that each radiator 7 can be separately controlled, and a beam formed in each transmission channel 10 can be separately controlled, thereby improving communication performance of the leaky-wave antenna 4.

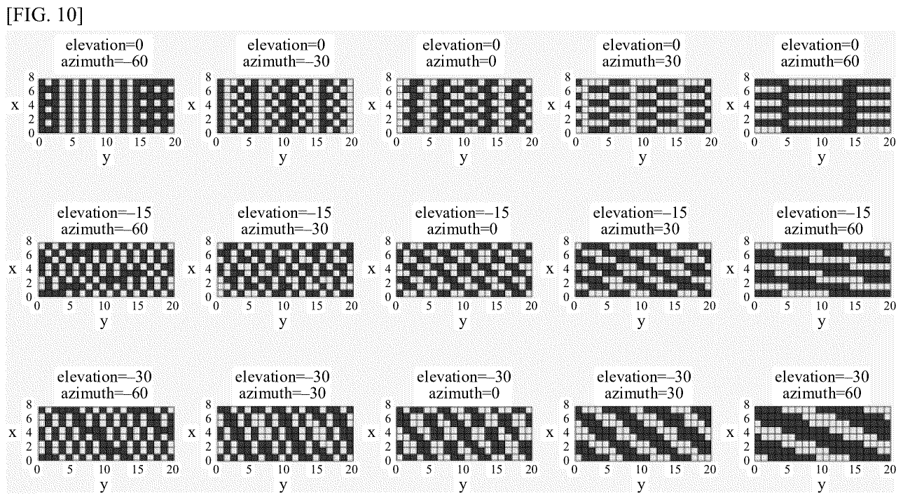

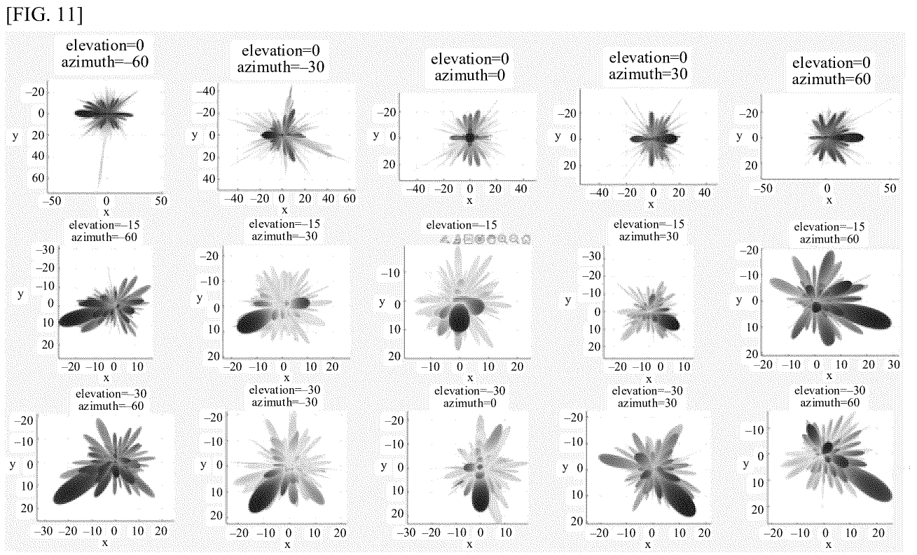

In the foregoing embodiment, whether a corresponding radiator 7 (as shown in FIG. 6) transmits a signal outwards may be separately controlled. Refer to FIG. 10. A black square in the figure represents that the radiator 7 does not transmit a signal outwards, and a gray square in the figure represents that the radiator 7 transmits a signal outwards. According to a 1^{st} solution in a 1^{st} row in FIG. 10, radiators 7 disposed in an array are controlled to transmit signals, and a shape of an obtained beam is a 1^{st} shape in a 1^{st} row in FIG. 11; according to a 2^{nd} solution in the 1^{st} row in FIG. 10, radiators 7 disposed in the array are controlled to transmit signals, and a shape of an obtained beam is a 2^{nd} shape in the 1^{st} row in FIG. 11; and so on. It can be learned that beams with different angles may be formed by controlling, according to different solutions, the radiators 7 in the array, thereby increasing a scanning range of the leaky-wave antenna 4. In addition, in a scanning process of the leaky-wave antenna 4, an aperture area of the leaky-wave antenna 4 is an area of the entire leaky-wave antenna 4, thereby improving aperture efficiency of the leaky-wave antenna 4.

Still refer to FIG. 6. In this embodiment of this application, the leaky-wave antenna 4 further includes a first conductive layer 21, the first conductive layer 21 and the grounding layer 6 are disposed in parallel at intervals, and the first conductive layer 21 is located on a side that is of the grounding layer 6 and that faces the transmission channels 10 (as shown in FIG. 3). In the foregoing implementation in which the leaky-wave antenna 4 includes the first dielectric layer 18, the first conductive layer 21 is located on a side that is of the first dielectric layer 18 and that is away from the grounding layer 6. The first conductive layer 21 includes a plurality of pads 22 and bias lines 16, each pad 22 is grounded, and one end of each variable impedance device 15 is connected to one pad 22. In the foregoing implementation in which the leaky-wave antenna 4 includes the PIN diodes 17, each pad 22 is located on a side that is of the first dielectric layer 18 and that is away from the grounding layer 6 and that is close to a corresponding PIN diode 17, one end that is of the pad 22 and that is close to the PIN diode 17 is connected to an end of the PIN diode 17, and an end that is of the pad 22 and that is away from the PIN diode 17 is grounded. Each bias line 16 is located on the side that is of the first dielectric layer 18 and that is away from the grounding layer 6, and is located at an end that is close to a corresponding PIN diode 17 and that is away from the pad 22. An end that is of the bias line 16 and that is close to the PIN diode 17 is connected to an end that is of the PIN diode 17 and that is away from the pad 22. The bias line 16 is configured to supply a voltage to the PIN diode 17. Based on the foregoing arrangement, one end of the variable impedance device 15 is grounded via the pad 22, and the other end is connected to one bias line 16, so that each bias line 16 can be used to control each variable impedance device 15 to be turned off or turned on, and whether a corresponding radiator 7 transmits a signal outwards is separately controlled.

Still refer to FIG. 6. In this embodiment of this application, the leaky-wave antenna 4 further includes a plurality of first conductive structures 23, each first conductive structure 23 is disposed between each pad 22 and the corresponding grounding layer 6, and the pad 22 is connected to the grounding layer 6 via the first conductive structure 23. In an implementation in which the leaky-wave antenna 4 includes the first dielectric layer 18, the first conductive structure 23 penetrates the first dielectric layer 18, one end of the first conductive structure 23 is connected to the pad 22, and the other end of the first conductive structure 23 is connected to the grounding layer 6. Based on the foregoing arrangement, because the grounding layer 6 and the pad 22 at the first conductive layer 21 both need to be grounded, after the first conductive structure 23 connects the pad 22 to the grounding layer 6, the grounding layer 6 and the pad 22 can be both grounded by grounding only the pad 22 or the grounding layer 6, thereby reducing a quantity of ground lines of the leaky-wave antenna 4, and reducing difficulty in manufacturing ground lines of the leaky-wave antenna 4.

In the foregoing embodiment, the first conductive structure 23 is connected to the pad 22, and the pad 22 is located on a left side of the PIN diode 17. Therefore, the PIN diode 17 is located on a right side of the first conductive structure 23. Along a direction perpendicular to an array, the first conductive structure 23 penetrates the first dielectric layer 18, and is connected to a part that is of the grounding layer 6 and that is located on a left side of the slot 12, so that the slot 12 is also located on the right side of the first conductive structure 23. In this case, when the PIN diode 17 is in an off state, in a process in which an electromagnetic wave passes through the PIN diode 17 and the slot 12, the grounded first conductive structure 23 can be prevented from affecting transmission of the electromagnetic wave.

Still refer to FIG. 6. In this embodiment of this application, the leaky-wave antenna 4 further includes a second conductive layer 24. The second conductive layer 24 and the grounding layer 6 are disposed in parallel at intervals. The second conductive layer 24 is located on a side that is of the grounding layer 6 and that is away from the first conductive layer 21. The second conductive layer 24 includes a plurality of first conducting lines 25 disposed at intervals, and each first conducting line 25 is connected to one bias line 16. Based on the foregoing arrangement, each bias line 16 is connected to a corresponding first conducting line 25. In this case, energizing the first conducting line 25 is equivalent to energizing the bias line 16 connected to the first conducting line 25, so that the bias line 16 supplies a voltage to the variable impedance device 15. In addition, because the second conductive layer 24 is located on the side that is of the grounding layer 6 and that is away from the first conductive layer 21, that is, the first conducting line 25 and the bias line 16 are disposed at different layers, a layout of the first conducting line 25 is flexible, so that an interconnection between adjacent first conducting lines 25 can be avoided, and an interconnection between adjacent corresponding bias lines 16 can also be avoided.

In the foregoing embodiment, the leaky-wave antenna 4 further includes a plurality of second conductive structures 26, and the first conducting line 25 is connected to the corresponding bias line 16 via the second conductive structure 26. Based on the foregoing arrangement, because the first conducting line 25 and the bias line 16 are disposed at different layers, one end of the second conductive structure 26 is connected to the first conducting line 25, and the other end of the second conductive structure 26 is connected to the corresponding bias line 16, thereby implementing a connection between the first conducting line 25 and the corresponding bias line 16.

Still refer to FIG. 6. In an implementation in which the leaky-wave antenna 4 includes the first dielectric layer 18 and the second dielectric layer 19, the leaky-wave antenna 4 may further include a third dielectric layer 27, the third dielectric layer 27 is located on a side that is of the second dielectric layer 19 and that is away from the first dielectric layer 18, and the third dielectric layer 27 and the second dielectric layer 19 are bonded together by a second prepreg 28, where both the third dielectric layer 27 and the second prepreg 28 may be made of insulating materials. In this implementation, the radiators 7 are located on a side that is of the third dielectric layer 27 and that is away from the first dielectric layer 18. For example, a thickness of the third dielectric layer 27 is 0.508 mm, and a thickness of the second prepreg 28 is 0.2 mm. With reference to the foregoing embodiment, the second conductive layer 24 is located between the second dielectric layer 19 and the second prepreg 28, one end of the second conductive structure 26 is connected to the bias line 16, and along the direction perpendicular to the array, the other end of the second conductive structure 26 penetrates the first dielectric layer 18, the first prepreg 20, and the second dielectric layer 19, and is connected to the first conducting line 25.

In the foregoing implementation, a first clearance hole 29 is provided at the grounding layer 6, and the second conductive structure 26 passes through the first clearance hole 29. Based on the foregoing arrangement, because the grounding layer 6 needs to be grounded, the second conductive structure 26 passes through the first clearance hole 29, so that insulation between the second conductive structure 26 and the grounding layer 6 is implemented, thereby avoiding a failure of the corresponding bias line 16 caused by an electric leakage between the second conductive structure 26 and the grounding layer 6.

In the implementation in which the leaky-wave antenna 4 includes the first dielectric layer 18 and the second dielectric layer 19, because the grounding layer 6 is located between the first dielectric layer 18 and the first prepreg 20, in a process in which the first dielectric layer 18 and the second dielectric layer 19 are bonded together by the first prepreg 20, the first clearance hole 29 is filled with a part of the first prepreg 20, and after the second conductive structure 26 passes through the first clearance hole 29, the part that is of the first prepreg 20 and that is made of an insulating material exists between the second conductive structure 26 and the grounding layer 6, thereby implementing insulation between the second conductive structure 26 and the grounding layer 6.

In the foregoing implementation, one end of the second conductive structure 26 is connected to the bias line 16, and the bias line 16 is located on a right side of the PIN diode 17. Therefore, the PIN diode 17 is located on a left side of the second conductive structure 26. Along the direction perpendicular to the array, the second conductive structure 26 penetrates the first dielectric layer 18, the first prepreg 20, and the second dielectric layer 19, and is connected to the first conducting line 25, so that the slot 12 and the radiator 7 are also located on the left side of the second conductive structure 26. In this case, when the PIN diode 17 is in the off state, in a process in which an electromagnetic wave passes through the PIN diode 17 and the slot 12, and is transmitted to the radiator 7, the second conductive structure 26 can be prevented from affecting transmission of the electromagnetic wave.

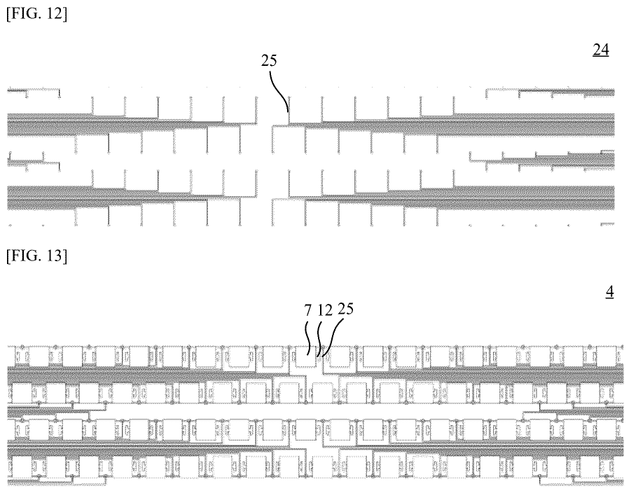

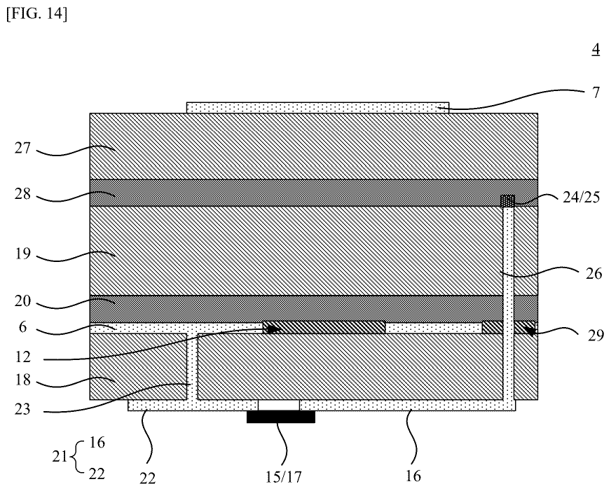

Refer to FIG. 12 and FIG. 13. In the foregoing implementation, there is a spacing between a plane that is perpendicular to the row direction and on which the first conducting lines 25 are located and a plane that is perpendicular to the row direction and on which the radiators 7, the slots 12, and the PIN diodes 17 are located. Refer to FIG. 14. Although in a vertical direction in the figure, the first conducting line 25 is located between the second dielectric layer 19 and the second prepreg 28, in a horizontal direction in the figure, the first conducting line 25 is located on a right side of the radiator 7, the slot 12, and the PIN diode 17 as a whole, so that when the PIN diode 17 is in an off state, in a process in which an electromagnetic wave passes through the PIN diode 17 and the slot 12, and is transmitted to the radiator 7, the first conducting line 25 is prevented from affecting transmission of the electromagnetic wave.

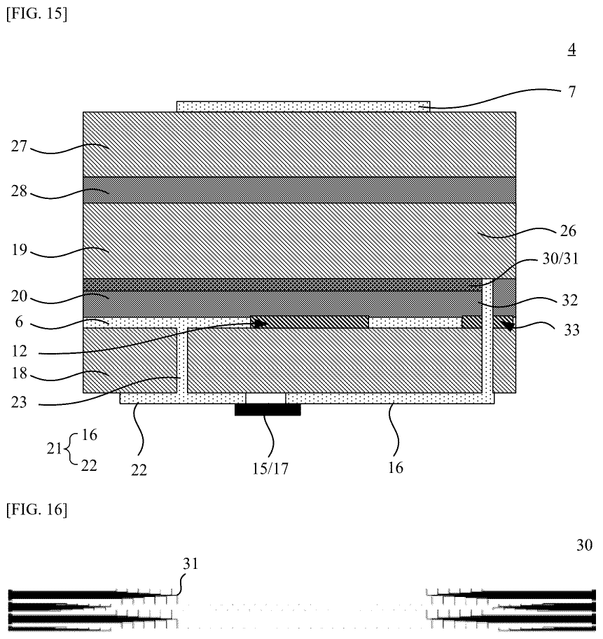

Still refer to FIG. 15. In this embodiment of this application, the leaky-wave antenna 4 may further include a third conductive layer 30, where the third conductive layer 30 and the grounding layer 6 are disposed in parallel at intervals, and the third conductive layer 30 is located between the second conductive layer 24 and the grounding layer 6. The third conductive layer 30 includes a plurality of second conducting lines 31 disposed at intervals, each second conducting line 31 is connected to one bias line 16, several bias lines 16 are connected to the second conducting lines 31, and remaining bias lines 16 are connected to first conducting lines 25.

Based on the foregoing arrangement, one bias line 16 is connected to a corresponding second conducting line 31. In this case, energizing the second conducting line 31 is equivalent to energizing the bias line 16 connected to the second conducting line 31, so that the bias line 16 supplies a voltage to a variable impedance device 15. In addition, because the third conductive layer 30 is located between the second conductive layer 24 and the grounding layer 6, that is, the second conducting line 31 and the bias line 16 are disposed at different layers, a layout of the second conducting line 31 is flexible, so that an interconnection between adjacent second conducting lines 31 can be avoided, and an interconnection between adjacent corresponding bias lines 16 can also be avoided. In addition, because several bias lines 16 are connected to the second conducting lines 31, the remaining bias lines 16 are connected to the first conducting lines 25, and the third conductive layer 30 and the second conductive layer 24 are different layers, compared with an embodiment in which the leaky-wave antenna 4 includes only the second conductive layer 24, in this embodiment, the third conductive layer 30 may be connected to another bias line 16, thereby increasing a quantity of radiators 7 that may be disposed for the leaky-wave antenna 4, and facilitating expansion of the leaky-wave antenna 4 along the row direction or the column direction.

In the foregoing embodiment, the leaky-wave antenna 4 further includes a plurality of third conductive structures 32, and the second conducting line 31 is connected to the corresponding bias line 16 via the third conductive structure 32. Based on the foregoing arrangement, because the second conducting line 31 and the bias line 16 are disposed at different layers, one end of the third conductive structure 32 is connected to the second conducting line 31, and the other end of the third conductive structure 32 is connected to the corresponding bias line 16, thereby implementing a connection between the second conducting line 31 and the corresponding bias line 16.

In an implementation in which the leaky-wave antenna 4 includes the first dielectric layer 18, the second dielectric layer 19, and the third dielectric layer 27, the third conductive layer 30 is located between the second dielectric layer 19 and the first prepreg 20, one end of the third conductive structure 32 is connected to the bias line 16, and along the direction perpendicular to the array, the other end of the third conductive structure 32 penetrates the first dielectric layer 18 and the first prepreg 20, and is connected to the second conducting line 31.

In the foregoing implementation, a second clearance hole 33 is provided at the grounding layer 6, and the third conductive structure 32 passes through the second clearance hole 33. Based on the foregoing arrangement, because the grounding layer 6 needs to be grounded, the third conductive structure 32 passes through the second clearance hole 33, so that insulation between the third conductive structure 32 and the grounding layer 6 is implemented, thereby avoiding a failure of the corresponding bias line 16 caused by an electric leakage between the third conductive structure 32 and the grounding layer 6.

In the implementation in which the leaky-wave antenna 4 includes the first dielectric layer 18 and the second dielectric layer 19, because the grounding layer 6 is located between the first dielectric layer 18 and the first prepreg 20, in a process in which the first dielectric layer 18 and the second dielectric layer 19 are bonded together by the first prepreg 20, the second clearance hole 33 is filled with a part of the first prepreg 20, and after the third conductive structure 32 passes through the second clearance hole 33, the part that is of the first prepreg 20 and that is made of an insulating material exists between the third conductive structure 32 and the grounding layer 6, thereby implementing insulation between the third conductive structure 32 and the grounding layer 6.

In the foregoing implementation, one end of the third conductive structure 32 is connected to the bias line 16, and the bias line 16 is located on a right side of the PIN diode 17. Therefore, the PIN diode 17 is located on a left side of the third conductive structure 32. Along the direction perpendicular to the array, the third conductive structure 32 penetrates the first dielectric layer 18 and the first prepreg 20, and is connected to the second conducting line 31, so that the slot 12 and the radiator 7 are also located on the left side of the third conductive structure 32. In this case, when the PIN diode 17 is in an off state, in a process in which an electromagnetic wave passes through the PIN diode 17 and the slot 12, and is transmitted to the radiator 7, the third conductive structure 32 can be prevented from affecting transmission of the electromagnetic wave.

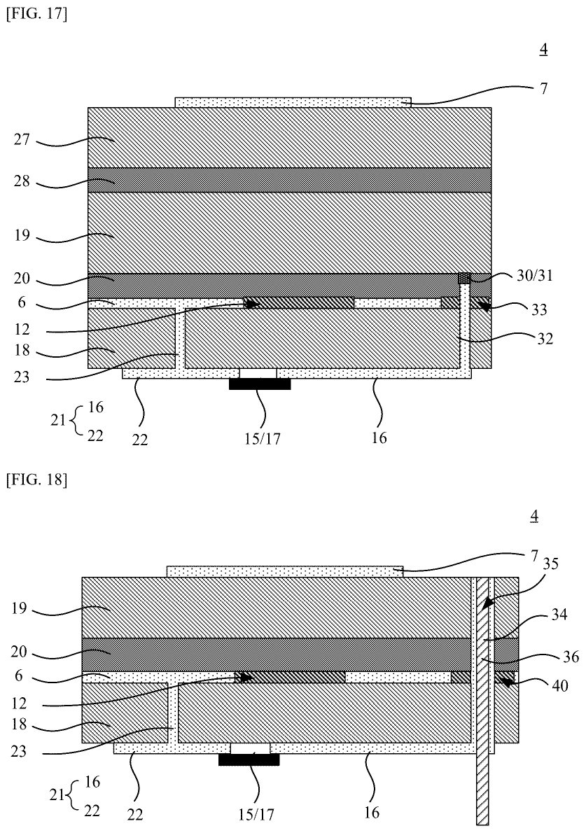

Refer to FIG. 16. In the foregoing implementation, there is a spacing between a plane that is perpendicular to the row direction and on which the second conducting lines 31 are located and a plane that is perpendicular to the row direction and on which the radiators 7, the slots 12, and the PIN diodes 17 are located. Refer to FIG. 17. Although in a vertical direction in the figure, the second conducting line 31 is located between the first dielectric layer 18 and the first prepreg 20, in a horizontal direction in the figure, the second conducting line 31 is located on a right side of the radiator 7, the slot 12, and the PIN diode 17 as a whole, so that when the PIN diode 17 is in an off state, in a process in which an electromagnetic wave passes through the PIN diode 17 and the slot 12, and is transmitted to the radiator 7, the second conducting line 31 is prevented from affecting transmission of the electromagnetic wave.

Refer to FIG. 18. In this embodiment of this application, the leaky-wave antenna 4 may further include a plurality of pins 34. Each pin 34 is connected to one bias line 16, and a center line of the pin 34 is perpendicular to the grounding layer 6.

Based on the foregoing arrangement, each bias line 16 is connected to a corresponding pin 34. In this case, energizing the pin 34 is equivalent to energizing the bias line 16 connected to the pin 34, so that the bias line 16 supplies a voltage to a variable impedance device 15. In addition, because the center line of the pin 34 is perpendicular to the grounding layer 6, the bias line 16 is not led out along the row direction or the column direction, and a size of the leaky-wave antenna 4 in the row direction or the column direction can be reduced, so that a quantity of radiators 7 is increased for the leaky-wave antenna 4 in the row direction or the column direction.

In an implementation in which the leaky-wave antenna 4 further includes the first dielectric layer 18 and the second dielectric layer 19, the leaky-wave antenna 4 further includes a plurality of through-holes 35 disposed in an array, and each through-hole 35 runs through the first dielectric layer 18 and the second dielectric layer 19. A conductive side wall 36 is disposed at a through-hole wall of the through-hole 35, the conductive side wall 36 is connected to a corresponding bias line 16, and each pin 34 is arranged through one through-hole 35. Based on the foregoing arrangement, each pin 34 is inserted into a corresponding through-hole 35, and is connected to the corresponding bias line 16 through the conductive side wall 36 of the through-hole 35. As shown in the figure, the pin 34 may penetrate the first conductive layer 21 from the bottom, and correspondingly, the top of the pin 34 may be fastened with the conductive side wall 36 through soldering, to facilitate welding. In this way, the pin 34 may be connected to the conductive side wall 36, so that energizing the pin 34 is equivalent to energizing the conductive side wall 36 of the through-hole 35 that corresponds to the pin 34, and then equivalent to energizing the bias line 16 that corresponds to the pin 34. In addition, a relative position between the pin 34 and the conductive side wall 36 may be fixed, to prevent the pin 34 from being disconnected from the conductive side wall 36 or from being in poor contact with the conductive side wall 36.

It may be understood that one end that is of the pin 34 and that is away from the radiator 7 may be connected to another plug-in device, to control a corresponding variable impedance device 15 via the pin 34. The plug-in device may include a through-hole or another circuit board.

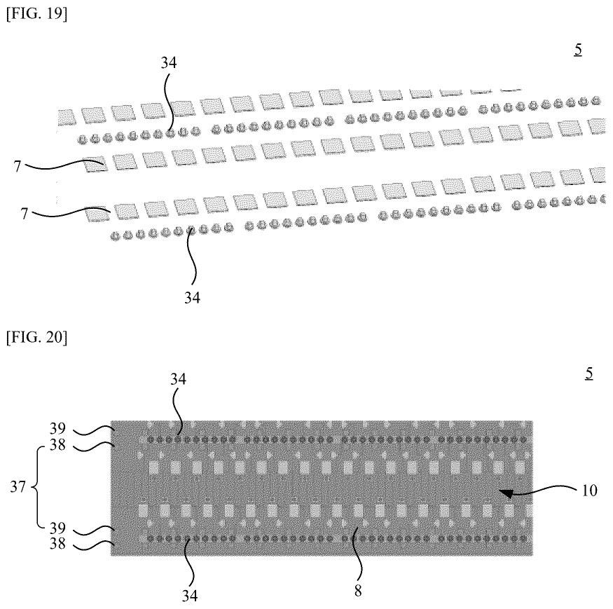

Refer to FIG. 19 and FIG. 20. In the foregoing implementation, the waveguide structure 5 may include the bottom plate 8 and a plurality of waveguide sub-structures 37 that are disposed on the bottom plate 8 and that extend along the row direction. The plurality of waveguide sub-structures 37 are disposed at intervals along the column direction. The waveguide sub-structure 37 includes a plurality of first pillars 38 that extend along the row direction and a plurality of second pillars 39 that extend along the row direction, one row of first pillars 38 and one row of second pillars 39 in a same waveguide sub-structure 37 form a transmission channel 10.

In the foregoing implementation, a projection that is of one row of pins 34 corresponding to one row of slots 12 and that is on the waveguide structure 5 is located between adjacent transmission channels 10. In other words, one row of pins 34 is located between one row of second pillars 39 in a waveguide sub-structure 37 and one row of first pillars 38 that belong to another waveguide sub-structure 37 and that are adjacent to the row of second pillars 39. Based on the foregoing arrangement, the pin 34 is located between adjacent transmission channels 10, so that the pin 34 can be prevented from affecting transmission of an electromagnetic wave on the transmission channel 10.

Still refer to FIG. 18. In the foregoing implementation, the grounding layer 6 may further include a third clearance hole 40, and the conductive side wall 36 passes through the third clearance hole 40. Because the grounding layer 6 needs to be grounded, the conductive side wall 36 passes through the third clearance hole 40, so that insulation between the conductive side wall 36 and the grounding layer 6 is implemented, thereby avoiding a failure of the corresponding bias line 16 caused by an electric leakage between the conductive side wall 36 and the grounding layer 6.

In an implementation in which the leaky-wave antenna 4 includes the first dielectric layer 18 and the second dielectric layer 19, because the grounding layer 6 is located between the first dielectric layer 18 and the first prepreg 20, in a process in which the first dielectric layer 18 and the second dielectric layer 19 are bonded together by the first prepreg 20, the third clearance hole 40 is filled with a part of the first prepreg 20, and after the conductive side wall 36 passes through the third clearance hole 40, the part that is of the first prepreg 20 and that is made of an insulating material exists between the conductive side wall 36 and the grounding layer 6, thereby implementing insulation between the conductive side wall 36 and the grounding layer 6.

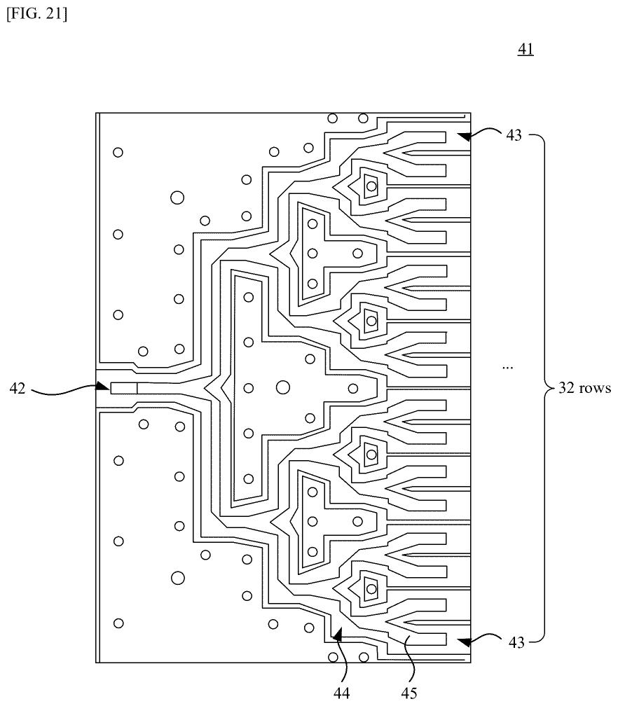

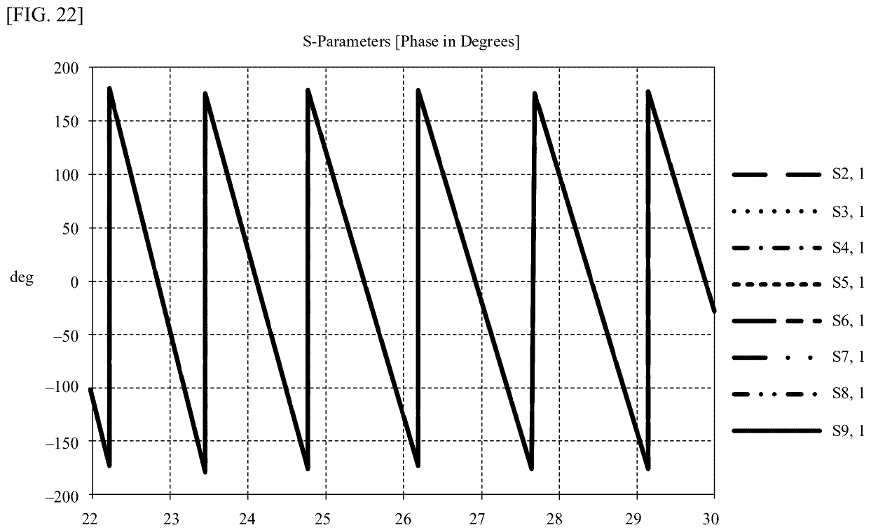

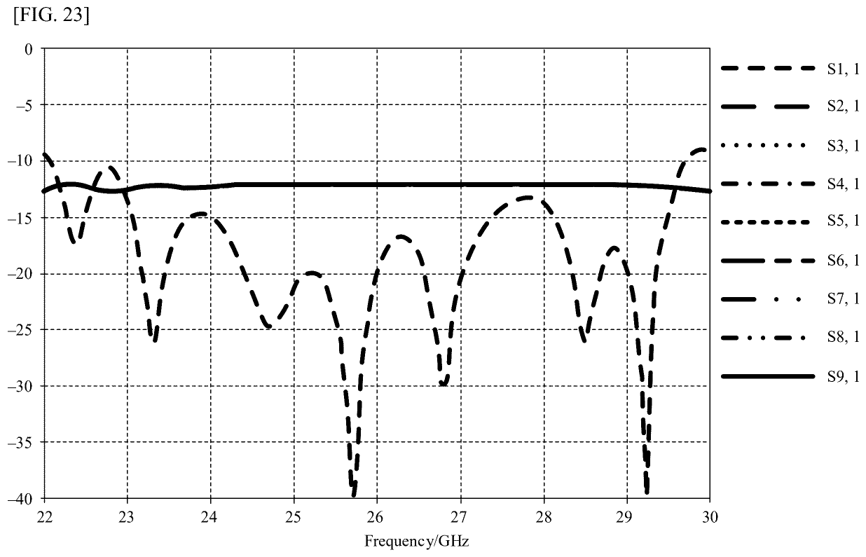

Refer to FIG. 21. In this embodiment of this application, the leaky-wave antenna 4 further includes a power splitter 41. The power splitter 41 includes an input end 42 and a plurality of output ends 43, and each output end 43 is connected to the input end 42. Each output end 43 is configured to send a signal to one transmission channel 10 (as shown in FIG. 3). Based on the foregoing arrangement, all the output ends 43 may output electromagnetic waves with a same amplitude and a same phase, so that electromagnetic waves transmitted in all transmission channels 10 have a same amplitude and a same phase. Refer to FIG. 22. In the figure, a horizontal coordinate is a frequency of an input electromagnetic wave, and a vertical coordinate is a phase of an electromagnetic wave output by each output end 43. S2, 1 represents a phase that is of a measured electromagnetic wave that is input by an input end 42 and that is output by a 1^{st} output end 43; S3, 1 represents a phase that is of a measured electromagnetic wave that is input by the input end 42 and that is output by a 2^{nd} output end 43; and so on. (Only S1, 1 to S9, 1 are marked in the figure.) It can be learned that a curve for S2, 1 to a curve for S9, 1 fully overlap, indicating that electromagnetic waves output by the output ends 43 have a same phase. Refer to FIG. 23. In the figure, a horizontal coordinate is a frequency of an input electromagnetic wave, and a vertical coordinate is a reflection coefficient in measurement for an input end 42 and each output end 43. S1, 1 represents a reflection coefficient in measurement, for the input end 42, on an electromagnetic wave that is input by the input end 42; S2, 1 is a reflection coefficient in measurement, for a 1^{st} output end 43, on the electromagnetic wave that is input by the input end 42; S3, 1 is a reflection coefficient in measurement, for a 2^{nd} output end 43, on the electromagnetic wave that is input by the input end 42; and so on. (Only S1, 1 to S9, 1 are marked in the figure.) Because all output ends 43 output electromagnetic waves with a same amplitude and a same phase, a curve for S2, 1 to a curve for S9, 1 fully overlap. It can be learned from FIG. 23 that, for a range of a frequency of the electromagnetic wave from 24 GHz to 28 GHz, all output ends 43 have a small reflection coefficient.

Still refer to FIG. 21. In an implementation of the communication device 1 provided in embodiments of this application, one end of the radio frequency unit 3 (as shown in FIG. 1) is connected to the building baseband unit 2 (as shown in FIG. 1), and the other end of the radio frequency unit 3 is connected to the input end 42.

Still refer to FIG. 21. In the foregoing implementation, an input channel 44 is disposed between the input end 42 and each output end 43 in the power splitter 41, the power splitter 41 may further include a second ridge structure 45, one second ridge structure 45 is disposed in each input channel 44, and the second ridge structure 45 extends along a signal transmission direction. Based on the foregoing arrangement, the second ridge structure 45 is disposed on the input channel 44, so that a cut-off frequency of an electromagnetic wave on each input channel 44 of the power splitter 41 is reduced, and a resonance frequency of the electromagnetic wave can be reduced. To maintain the resonance frequency of the electromagnetic wave, a size that is of the power splitter 41 and that is in an arrangement direction of each input channel 44 can be reduced. Therefore, the cut-off frequency of the electromagnetic wave on each input channel 44 of the power splitter 41 is reduced. This helps reduce the size that is of the power splitter 41 and that is in the arrangement direction of each input channel 44.

Still refer to FIG. 21. In some embodiments, there may be one power splitter 41. With reference to FIG. 2, in the figure, the power splitter 41 is on a left side of the waveguide structure 5, and a wave-absorbing material is on a right side of the waveguide structure 5 and is configured to absorb an electromagnetic wave transmitted from the transmission channel 10 (as shown in FIG. 3).

In some other embodiments, there are two power splitters 41. One power splitter 41 is disposed at one end of the transmission channel 10, and the other power splitter 41 is disposed at the other end of the transmission channel 10. Based on the foregoing arrangement, the power splitter 41 located at one end of the transmission channel 10 is configured to input an electromagnetic wave into the transmission channel 10, and the power splitter 41 located at the other end of the transmission channel 10 is configured to integrate electromagnetic waves transmitted from the transmission channel 10 and release the electromagnetic waves into air.

In the foregoing embodiments, an input end 42 of the power splitter 41 disposed at one end of the transmission channel 10 is configured to be connected to the radio frequency unit 3, and an output end 43 of the power splitter 41 located at the other end of the transmission channel 10 may be arranged with the wave-absorbing material. In this way, after the electromagnetic waves transmitted from the transmission channel 10 are integrated by the power splitter 41, the wave-absorbing material may absorb the transmitted electromagnetic waves.

It should be noted that, in the descriptions of embodiments of this application, unless otherwise specified and limited, the terms “interconnect” and “connect” should be understood in a broad sense. For example, the terms may indicate a fixed connection or an integral connection; or may indicate a mechanical connection or an electrical connection; or may indicate a direct connection, an indirect connection through an intermediate medium, or internal communication between two components. A person skilled in the art may understand specific meanings of the terms in embodiments of this application based on a specific situation.

Finally, it should be noted that the foregoing embodiments are merely intended for describing the technical solutions of embodiments of this application but not for limiting this application. Although this application is described in detail with reference to the foregoing embodiments, a person of ordinary skill in the art should understand that modifications may still be made to the technical solutions described in the foregoing embodiments or equivalent replacements are made to some or all technical features thereof, without departing from the scope of the technical solutions of embodiments of this application.

What is claimed is:

1. A leaky-wave antenna comprising:
a waveguide structure comprising a plurality of transmission channels disposed in parallel at intervals;
a grounding layer, wherein a plurality of slots are provided in an array at the grounding layer, and slots of each row of the array are associated with one of the plurality of transmission channels;
a plurality of radiators, wherein each radiator of the plurality of radiators is associated with one of the plurality of slots, and wherein each radiator of the plurality of radiators is located on a side of the one slot and away from the transmission channel associated with the one slot; and
a plurality of variable impedance devices, wherein each of the plurality of variable impedance devices is associated with one of the plurality of slots, wherein each the plurality of variable impedance devices is located on a side of the one slot facing the transmission channel, wherein one end of each of the plurality of variable impedance devices is grounded, and wherein another end of each of the plurality of variable impedance devices is connected to a bias line.

2. The leaky-wave antenna according to claim 1, wherein the leaky-wave antenna further comprises a first conductive layer, wherein the first conductive layer and the grounding layer are disposed in parallel at intervals, and wherein the first conductive layer is located on a side of the grounding layer and faces the transmission channels; and
the first conductive layer comprises a plurality of pads and bias lines, wherein each pad is grounded, and wherein one end of each variable impedance device is connected to a pad.

3. The leaky-wave antenna according to claim 2, wherein a first conductive structure is disposed between each pad and the grounding layer, and wherein the pad is connected to the grounding layer via the first conductive structure.

4. The leaky-wave antenna according to claim 2, wherein the leaky-wave antenna further comprises a second conductive layer, wherein the second conductive layer and the grounding layer are disposed in parallel at intervals, and wherein the second conductive layer is located on a side of the grounding layer that is away from the first conductive layer; and
the second conductive layer comprises a plurality of first conducting lines disposed at intervals, and wherein each first conducting line is connected to one bias line.

5. The leaky-wave antenna according to claim 4, wherein a second conductive structure is disposed between each first conducting line and the associated bias line, and wherein the first conducting line is connected to the associated bias line via the second conductive structure.

6. The leaky-wave antenna according to claim 5, wherein a first clearance hole is provided at the grounding layer, and wherein the second conductive structure passes through the first clearance hole.

7. The leaky-wave antenna according to claim 4, further comprising a third conductive layer, wherein the third conductive layer and the grounding layer are disposed in parallel at intervals, and wherein the third conductive layer is located between the second conductive layer and the grounding layer; and
the third conductive layer comprises a plurality of second conducting lines disposed at intervals, wherein each second conducting line is connected to one bias line, wherein several bias lines are connected to the second conducting lines, and wherein remaining bias lines are connected to the first conducting lines.

8. The leaky-wave antenna according to claim 7, wherein a third conductive structure is disposed between each second conducting line and the associated bias line, and wherein the second conducting line is connected to the associated bias line via the third conductive structure.

9. The leaky-wave antenna according to claim 8, wherein a second clearance hole is provided at the grounding layer, and wherein the third conductive structure passes through the second clearance hole.

10. The leaky-wave antenna according to claim 1, wherein the leaky-wave antenna further comprises a plurality of pins, wherein each pin is connected to one bias line, and wherein a center line of the pin is perpendicular to the grounding layer.

11. The leaky-wave antenna according to claim 10, wherein the leaky-wave antenna further comprises:
a first dielectric layer;
a second dielectric layer; and
a plurality of through-holes disposed in an array,
wherein the first dielectric layer is disposed, in a stacked manner, between the grounding layer and the variable impedance devices,
wherein the second dielectric layer is disposed, in a stacked manner, between the grounding layer and the radiators,
wherein each through-hole runs through the first dielectric layer and the second dielectric layer,
wherein each pin is arranged through one through-hole, wherein a conductive side wall is disposed at a through-hole wall of the through-hole, and
wherein the conductive side wall is connected to an associated bias line.

12. The leaky-wave antenna according to claim 10, wherein a projection of one row of pins associated with one row of slots on the waveguide structure is located between adjacent transmission channels.

13. The leaky-wave antenna according to claim 1, further comprising a power splitter having an input end and a plurality of output ends, wherein each output end is connected to the input end, and each output end is configured to send a signal to one transmission channel.

14. The leaky-wave antenna according to claim 13, wherein there are two power splitters, wherein one power splitter is disposed at one end of the transmission channel, and wherein another power splitter is disposed at the other end of the transmission channel.

15. The leaky-wave antenna according to claim 1, wherein the waveguide structure comprises a bottom plate and a plurality of pillars disposed on the bottom plate, wherein the plurality of pillars are disposed in an array, and wherein the transmission channel is formed between two adjacent rows of pillars.

16. The leaky-wave antenna according to claim 15, wherein the waveguide structure further comprises a plurality of first ridge structures located on the transmission channels and extending along a signal transmission direction.

17. A communication device comprising:
a radio frequency unit and a leaky-wave antenna, wherein the radio frequency unit is configured to send a radio frequency signal to the leaky-wave antenna, and the leaky-wave antenna comprises:
a waveguide structure comprising a plurality of transmission channels disposed in parallel at intervals;
a grounding layer, wherein a plurality of slots are provided in an array at the grounding layer, and slots of each row of the array are associated with one of the plurality of transmission channels;
a plurality of radiators, and each radiator of the plurality of radiators is associated with one of the plurality of slots and wherein each radiator of the plurality of radiators is located on a side of the one slot and away from the transmission channel associated with the one slot; and
a plurality of variable impedance devices, wherein each variable impedance device is associated with one of the plurality of slots, wherein each of the plurality of variable impedance devices is located on a side of the one slot facing the transmission channel, wherein one end of each of the plurality of variable impedance devices is grounded, and wherein another end of each of the plurality of variable impedance devices is connected to a bias line.

18. The communication device according to claim 17, wherein the leaky-wave antenna further comprises a first conductive layer, wherein the first conductive layer and the grounding layer are disposed in parallel at intervals, and wherein the first conductive layer is located on a side of the grounding layer facing the transmission channels; and
the first conductive layer comprises a plurality of pads and bias lines, wherein each pad is grounded, and wherein one end of each variable impedance device is connected to one pad.

19. The communication device according to claim 18, wherein a first conductive structure is disposed between each pad and the grounding layer, and wherein the pad is connected to the grounding layer via the first conductive structure.

20. The communication device according to claim 18, wherein the leaky-wave antenna further comprises a second conductive layer, wherein the second conductive layer and the grounding layer are disposed in parallel at intervals, and wherein the second conductive layer is located on a side of the grounding layer and away from the first conductive layer; and
the second conductive layer comprises a plurality of first conducting lines disposed at intervals, wherein each of the plurality of first conducting lines is connected to a bias line.
